(19) United States
(12) Patent Application Publication
(10) Pub. No.: US 2008/0199232 A1
(43) Pub. Date: Aug. 21, 2008

(54) IMAGE HEATING APPARATUS

(75) Inventor: Taichi Takemura, Abiko-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/032,978

(22) Filed: Feb. 18, 2008

(30) Foreign Application Priority Data
Feb. 20, 2007 (JP) 2007-039336

(51) Int. Cl. G03G 15/20

(52) U.S. Cl. 399/329

(57) ABSTRACT

In an image heating apparatus, the following expressions are satisfied:

μ2<μ1

0.2<μ1<0.5

0.005<μ2<0.3

0.9<V2/V1<1.0

where μ1 is a friction coefficient between a fusing roller (heating rotary member) and a pressing belt (endless belt), μ2 is a friction coefficient between the pressing belt and a driving roller, V1 is a peripheral speed of the fusing roller, and V2 is a peripheral speed of the driving roller.

### BACKGROUND OF THE INVENTION

1. Field of the Invention

The present invention relates to an image heating apparatus for heating a toner image on a recording material.

Examples of the image heating apparatus include a fusing apparatus for heating and fusing a not-yet-fused toner image on a recording material, and a gloss increasing apparatus for heating a toner image having been fused on a recording material, to thereby increase a gross of the toner image. The image heating apparatus can be advantageously used, for example, in an electrophotographic image forming apparatus such as a copying machine, a printer, and a FAX.

2. Description of the Related Art

Hitherto, various types of fusing apparatuses have been proposed to fuse a not-yet-fused toner image in an electrophotographic image forming apparatus.

As one of the various types of fusing apparatuses, a belt fusing apparatus is proposed which can increase the length of a fusing nip to be adapted for image formation at a higher speed (see, e.g., Japanese Patent Laid-Open No. 8-166734 and No. 10-319772).

The belt fusing apparatus is constructed such that a pressing belt is disposed to come into pressure contact with a fusing roller and a pressing pad attached to an inner surface of the pressing belt is pushed against the fusing roller. As a result, the fusing nip having a sufficient length can be formed to span from the pressing pad to a belt suspension roller.

In the belt fusing apparatus described above, the fusing roller is rotated by a driving source, while the pressing belt is circulatively rotated by a sliding frictional force that is generated with the sliding movement of the pressing belt relative to the fusing roller. Stated another way, when a sheet is present at the fusing nip, the pressing belt receives a conveying force primarily through the sheet and the peripheral speed of the pressing belt is affected by the conveying speed of the sheet.

Thus, with the construction that the pressing belt is frictionally driven by the fusing roller to rotate in a circulating way, the conveying force applied to the pressing belt is changed depending the type of sheet, environmental conditions, and the kind of toner image. Therefore, the circulative rotation of the pressing belt becomes unstable in some cases.

It sometimes occurs, for example, that a large amount of not-yet-fused toner remains on the sheet over a wide area. In such a case, when the sheet enters the fusing nip, the dynamic friction coefficient between the fusing roller and the sheet tends to reduce, whereby the conveying force applied to the pressing belt is reduced. Consequently, the sheet slips relative to the fusing roller because of a reduction in the conveying speed of the sheet, and an image failure such as an image shear is caused. On that occasion, the peripheral speed of the pressing belt is assumed to be substantially the same as the conveying speed of the sheet.

For the above-described reason, the known method of driving the pressing belt cannot always ensure a high quality image.

In order to prevent the above-described reduction in the conveying speed of the sheet, an apparatus disclosed in Japanese Patent Laid-Open No. 2-222980 employs an override mechanism in a driving mechanism.

Even with the provision of such an override mechanism, however, the countermeasure for preventing the reduction in the conveying speed of the sheet is not sufficient for the reason given below.

According to the override mechanism, when the sheet is not present at the fusing nip, the pressing belt is circulatively rotated by a sliding frictional force that is generated with the sliding movement of the pressing belt relative to the fusing roller as with the belt fusing apparatuses disclosed in Japanese Patent Laid-Open No. 8-166734 and No. 10-319772. On the other hand, only when the sheet (toner image) slips relative to the fusing roller and the peripheral speed of the pressing belt becomes lower than the peripheral speed of the fusing roller, the pressing belt receives a driving input. Stated another way, a certain time is required, though it is slight, from the timing at which the peripheral speed of the pressing belt has become slower than that of the fusing roller to the timing at which a driving force is input to the pressing belt.

Thus, because the peripheral speed of the pressing belt is changed during a process of fusing the toner image onto the sheet, an image failure such as an image shear is similarly caused due to the speed change of the pressing belt.

### SUMMARY OF THE INVENTION

The present invention is directed to an image heating apparatus which can prevent image failure.

According to an aspect of the present invention, an image heating apparatus includes a heating rotary member configured to heat a toner image on a recording material at a nip portion, a driving unit configured to drive the heating rotary member, an endless belt arranged to form the nip portion between the heating rotary member and the endless belt, and a driving roller configured to drive the endless belt and to press the endless belt toward the heating rotary member. Further, the following expressions are satisfied:

μ2<μ1

0.2<μ1<0.5

0.005<μ2<0.3

0.9<V2/V1<1.0

where μ1 is a friction coefficient between the heating rotary member and the endless belt, μ2 is a friction coefficient between the endless belt and the driving roller, V1 is a peripheral speed of the heating rotary member, and V2 is a peripheral speed of the driving roller.

Further features of the present invention will become apparent from the following description of exemplary embodiments with reference to the attached drawings.

### BRIEF DESCRIPTION OF THE DRAWINGS

FIG. 1 is a schematic sectional view of an image forming apparatus.

FIG. 2 is a schematic sectional view of a fusing apparatus according to a first exemplary embodiment.

FIG. 3 is a schematic sectional view of a principal part of the fusing apparatus.

FIG. 4 is a schematic view showing a driving mechanism for the fusing apparatus.

FIG. 5 is an explanatory view showing frictional forces and speeds when a sheet is conveyed.

FIG. 6 is a graph showing results of measuring a gap α between a pressing belt and a driving roller.

FIG. 7 is an explanatory view illustrating the behavior of the pressing belt near the exit of a fusing nip.

FIG. 8 is a schematic sectional view showing a measurement system for measuring the friction coefficient.

FIG. 9 is a schematic sectional view of a fusing apparatus according to a second exemplary embodiment.

FIG. 10 is a schematic sectional view of another image forming apparatus.

### DESCRIPTION OF THE EMBODIMENTS

The present invention will be described in detail below in connection with exemplary embodiments. It is to be noted that the following exemplary embodiments are merely examples to which the present invention can be applied, and the present invention is not limited to the following exemplary embodiments.

### First Exemplary Embodiment

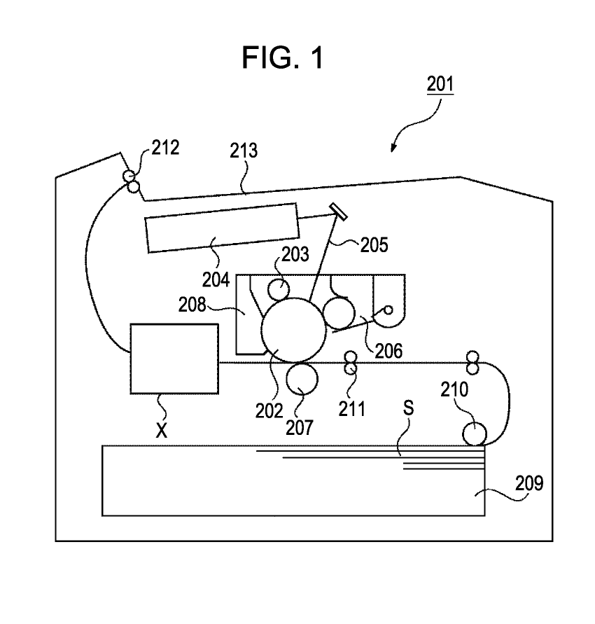

Prior to describing a fusing apparatus which is one practical form of an image heating apparatus according to a first exemplary embodiment of the present invention, an overall construction of the image forming apparatus is described with reference to FIG. 1.

The image forming apparatus shown in FIG. 1 is an electrophotographic image forming apparatus (so-called printer).

### (Image Forming Unit)

A description is first made of an image forming unit that is incorporated in an image forming apparatus 201 to form a toner image on a sheet, i.e., a recording material. The image forming apparatus 201 includes the following components.

A charger 203, serving as a charging unit, is disposed around a photoconductive drum 202, serving as an image bearing member, and the surface of the photoconductive drum 202 is uniformly charged by the charger 203. A light beam 205 corresponding to the image is irradiated from an exposure apparatus 204, serving as an exposure unit, so that an electrostatic latent image is formed on the surface of the photoconductive drum 202. The electrostatic latent image is developed by a developer 206, serving as a developing unit, to form a toner image. On the other hand, sheets S, i.e., recording materials, are stocked in a paper feed cassette 209 disposed in a lower portion of the image forming apparatus. The sheets are fed one by one with rotation of a paper feed roller 210. The sheet S is conveyed by a registration roller pair 211, serving as a conveying unit, in sync with the toner image on the photoconductive drum 202. The toner image on the photoconductive drum 202 is electrostatically transferred onto the sheet S when the sheet passes a transfer roller 207 serving as a transfer unit. The sheet S is further conveyed to a fusing apparatus X. Thereafter, the toner remaining on the photoconductive drum 202 is removed by a cleaning apparatus 208 serving as a cleaning unit.

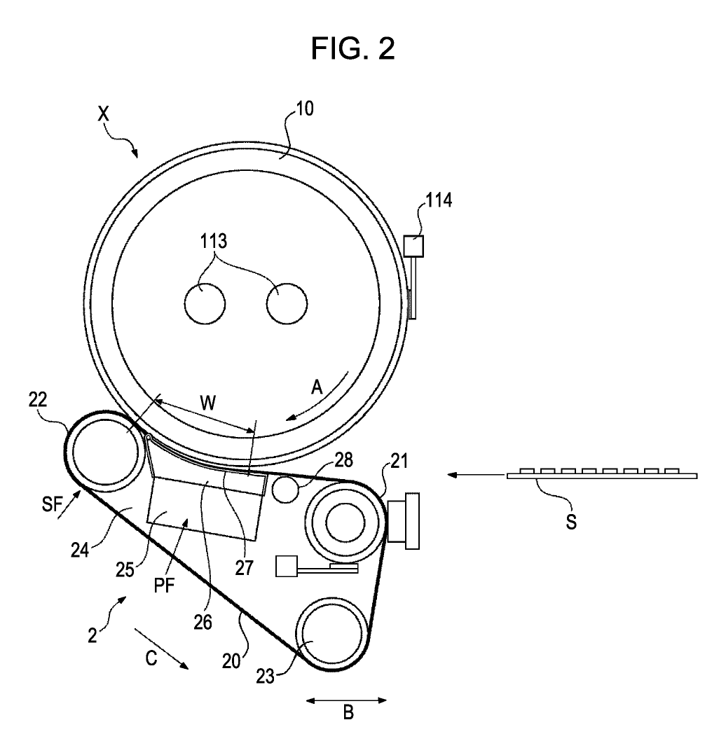

A not-yet-fused toner image (exaggeratively illustrated on the sheet S in FIG. 2) having been formed on the sheet S by the image forming unit is heated and pressed in the fusing apparatus X for fixing to the sheet S by fusing. Thereafter, the sheet S including the toner image fixed thereto is conveyed by an output roller pair 212 and is ejected onto an output tray 213 that is disposed at the top of the image forming apparatus.

### (Fusing Apparatus)

The construction of the fusing apparatus as one practical form of the image heating apparatus will be described next with reference to the drawings. The fusing apparatus X according to the first exemplary embodiment has, as described above, the function of heating and pressing the not-yet-fused toner image on the recording material for fixing thereto by fusing. FIG. 2 is a schematic sectional view of the fusing apparatus.

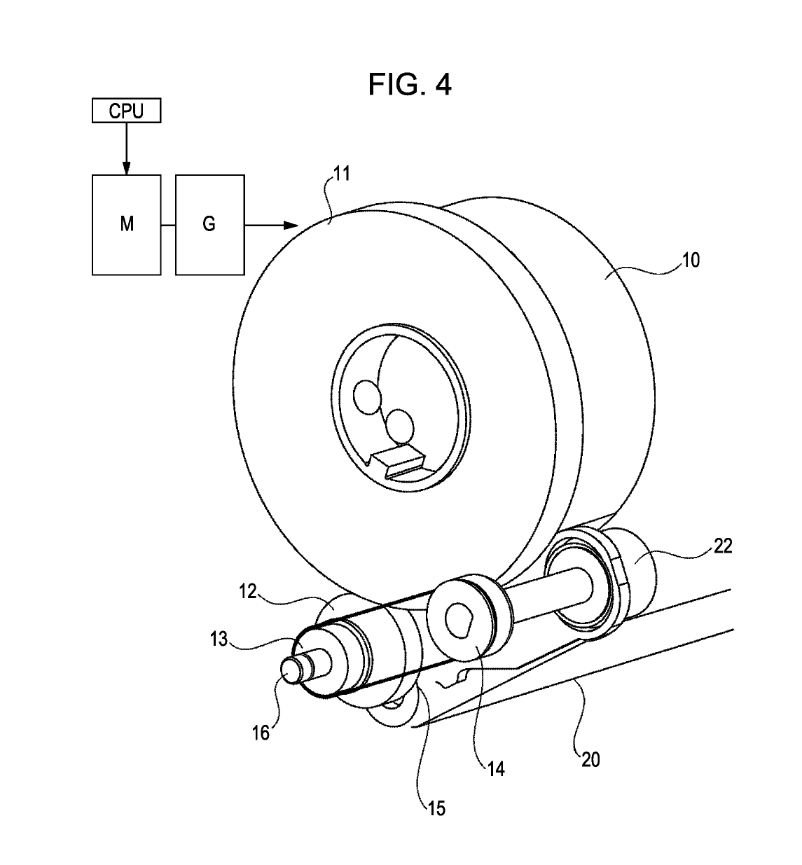

In the fusing apparatus X, as shown in FIG. 2, a fusing roller 10, serving as a heating rotary member (or a fusing rotary member), is disposed to be rotatable in a direction of an arrow A by a driving motor M and a driving gear train G (see FIG. 4) both of which serve as a driving unit. In other words, the fusing roller 10 is provided with a rotational driving force (torque) from the driving motor M.

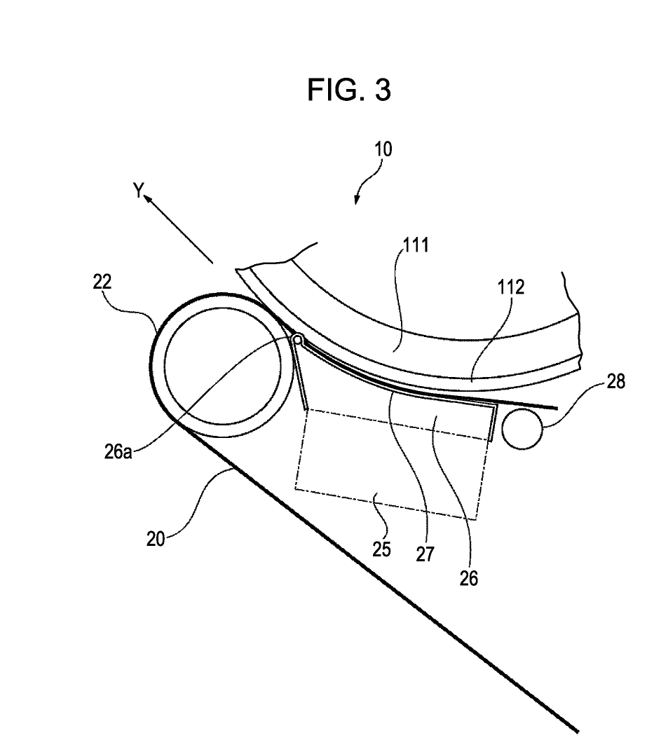

The fusing roller 10 includes, as shown in FIG. 3, a core metal 111 made of aluminum or other suitable metal, and an elastic layer 112 formed over the core metal 111 and made of, e.g., silicone rubber. In addition, over the elastic layer 112, a release layer can be laminated as a fluororesin layer, for example, to which the toner is hard to adhere.

A halogen heater 113, serving as a heating source, is disposed inside the fusing roller 10, and the fusing roller 10 is heated by heat generated from the halogen heater 113. A thermistor 114, serving as a temperature sensor, is disposed in contact with the surface of the fusing roller 10.

A control unit (CPU) (see FIG. 4) controls an amount of electric current supplied to the halogen heater 113 depending on the result detected by the thermistor 114 so that the surface of the fusing roller 10 is maintained at a predetermined fusing temperature. The control unit also has the function of a setting unit configured to set the peripheral speed of the fusing roller 10 and the peripheral speed of a driving roller 22 for a pressing belt 20 to respective predetermined values as described later.

Further, a belt unit 2 is disposed under the fusing roller 10. The pressing belt 20 in the form of an endless belt is supported to stretch under tension around an inlet roller 21, the driving roller 22, and a steering roller 23 such that it is circulatively rotated in a direction indicated by an arrow C. The pressing belt 20 can also be called an endless film for the reason that the thickness of the pressing belt 20 is within the range of 100 μm to 700 μm in practical use. In the illustrated example, the pressing belt 20 having the thickness of about 500 μm is used.

The driving roller 22 is made of a metal, such as SUS, and is pressed under a predetermined pressure by a pressing mechanism in a direction indicated by an arrow SF, i.e., toward the fusing roller 10 with the pressing belt 20 interposed between the driving roller 22 and the fusing roller 10. The driving roller 22 is provided with a rotational driving force (torque) from a driving mechanism described later.

The steering roller 23 is rotatable in a direction indicated by an arrow B only at one end side of its rotary shaft. In other words, the steering roller 23 has the function of swinging the pressing belt 20 in the widthwise direction thereof when the one end side of the steering roller 23 is displaced and inclined.

A halogen heater for heating the pressing belt 20 is built in the inlet roller 21.

A pressing pad unit 24 for forming a fusing nip W is fixedly disposed in an unrotatable manner between the inlet roller 21 and the driving roller 22. The pressing pad 24 includes a pressing base 25 made of a metal, such as SUS, and a pressing pad 26 made of, e.g., silicone rubber.

The surface of the pressing pad 26 is covered with a low-friction sliding sheet 27, which serves as a sheet-like member and is made of, e.g., PI (polyimide), in order to reduce sliding resistance between the pressing pad 26 and the pressing belt 20. The thus-constructed pressing pad unit 24 is pressed under a predetermined pressure in a direction indicated by an arrow PF, i.e., toward the fusing roller 10 with the pressing belt 20 interposed between the pressing pad unit 24 and the fusing roller 10.

Between the inlet roller 21 and the pressing pad unit 24, an oil applying roller 28 is disposed and serving as a unit for applying oil, i.e., a lubricant, to the pressing belt 20. The oil applying roller 28 is impregnated with silicone oil such that a certain amount of oil is constantly supplied to an inner surface of the pressing belt 20. With the supply of the oil, a frictional force generated between the pressing belt 20 and the sliding sheet 27 is reduced and durability is increased.

FIG. 3 is an enlarged view showing the vicinity of the driving roller 22. Because the driving roller 22 is pressed by the pressing mechanism toward the fusing roller 10 with the pressing belt 20 interposed between the driving roller 22 and the fusing roller 10, the elastic layer 112 of the fusing roller 10 is deformed into a recessed shape as illustrated. However, when the fusing roller 10 is rotated past a region where it is pressed by the driving roller 22, the elastic layer 112 of the fusing roller 10 returns to its original shape from the deformed shape.

Because the toner image on the sheet is melted and pressed at the fusing nip W, the sheet S tends to stick to the fusing roller 10. In spite of the sheet S tending to stick to the fusing roller 10, the sheet is easily separated from the fusing roller 10 for the reason that the elastic layer 112 of the fusing roller 10 is deformed by the driving roller 22. In other words, the sheet S is separated from the fusing roller 10 and is ejected in a direction indicated by an arrow Y by the action of its own stiffness.

Further, a metal wire 26a, serving as a bar-like member to prevent a pressure drop, is disposed at one end of the pressing pad 26 on the side close to the driving roller 22. The metal wire 26a is integral with the pressing pad 26. The elastic layer 12 of the fusing roller 10 is deformed by the metal wire 26a.

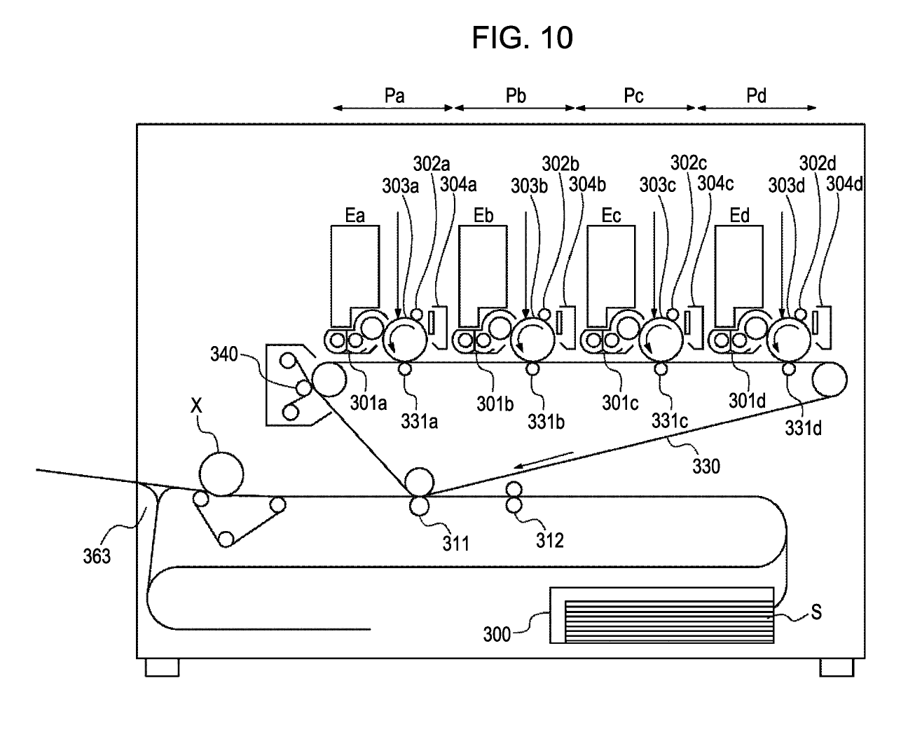

In the fusing apparatus X thus constructed, the fusing roller 10, the pressing belt 20, the pressing pad 24, and the driving roller 22 cooperatively form the fusing nip (nip portion) W that is elongated in the sheet conveying direction. With such a construction, the fusing nip can be formed at a larger width than that in the known fusing apparatus, which includes a fusing roller and a pressing roller, and the toner on the sheet can be satisfactorily melted in a shorter time. Therefore, the fusing apparatus of this exemplary embodiment is suitable for use in an image forming apparatus employing a large amount of toner, e.g., a color image forming apparatus described later with reference to FIG. 10.

### (Driving Mechanism of Fusing Apparatus)

FIG. 4 is a schematic view showing a driving mechanism for the fusing apparatus X. Note that while FIG. 4 illustrates a driving mechanism for transmitting the torque generated by the driving motor M to both the fusing roller 10 and the driving roller 22, the present invention is not limited to the illustrated example. The driving mechanism can also be constructed so as to rotate the fusing roller 10 and the driving roller 22 independently of each other by installing two sets of driving motors and torque transmitting mechanisms separately.

The driving mechanism primarily includes the driving motor M serving as a driving source, the driving gear train G, gears 11-14, and a transmission belt 15. The driving motor M is connected to the CPU such that the speed of the driving motor is controlled by the CPU.

The fusing gear 11 is fixed to one end of the fusing roller 10. A driving force from the driving motor M is input to the fusing gear 11 through the driving gear train G, whereby the fusing roller 10 is driven for rotation.

The first transmission gear 12 is meshed with the fusing gear 11 such that the driving force from the driving motor M is input to the fusing gear 11. Further, the first transmission gear 12 is fixed to a shaft 16 along with the second transmission gear 13.

The transmission belt 15 is looped over the second transmission gear 13 and the pressing gear 14, and a tension roller (not shown) is brought into pressure contact with the transmission belt 15 so that the transmission belt is stretched with a predetermined tension.

Further, the pressing gear 14 is rotated integrally with the driving roller 22 in a coaxial relation. Therefore, the driving force from the driving motor M is input to the driving roller 22 through a transmission line including the fusing gear 11, the first transmission gear 12, the second transmission gear 13, the transmission belt 15, and the pressing gear 14.

The driving roller 22 can be rotated at any desired peripheral speed by optionally selecting a combination of the number of teeth of each gear and the roller diameter. In this exemplary embodiment, those parameters are set such that the torque is input to the driving roller 22, which serves as a roller for driving the pressing belt 20, so as to satisfy the later-described relationships.

### (Setting Conditions for Driving of Fusing Apparatus)

Setting conditions for driving of the fusing apparatus X will be described below.

When the sheet S including the not-yet-fused toner image thereon is positioned in a zone of the fusing nip, a fusing process is to be performed without causing the not-yet-fused toner to slip relative to the fusing roller 10.

To perform the fusing process in such a manner, while inputting the driving force to the fusing roller 10 as described above, a driving force is separately input to the pressing belt 20 as well. In trying to realize such a construction, however, a difficulty arises in driving both the fusing roller and the pressing belt exactly at the same speed due to, e.g., tolerances of the various components of the driving mechanism.

Taking into account that difficulty, the technique of inputting the driving forces to the fusing roller and the pressing belt separately from each other is employed in this exemplary embodiment with an additional improvement described below.

In other words, while employing the technique of driving the fusing roller 10 and the pressing belt 20 separately from each other, the pressing belt 20 is further frictionally driven by the fusing roller 10. Herein, the expression “frictionally driven” means that two components are rotated substantially at the same peripheral speed by a frictional force transmitted from one to the other component.

To that end, as described later in detail, the dynamic friction coefficient between the driving roller and the inner surface of the pressing belt is set to be smaller than that between the fusing roller and the outer surface of the pressing belt in this exemplary embodiment. Note that, in the following description, the term “friction coefficient” means “dynamic friction coefficient” unless otherwise specified.

Also, in order to frictionally drive the pressing belt 20 for circulative rotation by the fusing roller 10, the friction coefficient between the driving roller and the inner surface of the pressing belt is set to a negligibly small value.

Further, in order to prevent the sheet S from being conveyed at a speed lower than the peripheral speed of the fusing roller 10, the surface of the pressing pad 26 tending to apply a braking force to the pressing belt 20 is covered with the low-friction sliding sheet 27 for reducing the sliding resistance between the pressing pad 26 and the pressing belt 20. In addition, the low-friction sliding sheet 27 has large asperities formed on its surface to further reduce the braking force applied to the pressing belt from the pressing pad.

Stated another way, the pressing pad 26 is set so as to satisfy the relationship of (conveying force applied to the pressing belt from the fusing roller)>(braking force acting on the pressing belt).

In order to even further reduce the braking force acting on the pressing belt 20, the oil is coated over the inner surface of the pressing belt by the oil applying roller 28. Accordingly, the frictional force generated between the driving roller and the inner surface of the pressing belt can be held at a negligible level.

As a result of conducting the studies, the inventor found that, if the peripheral speed (V2 described later) of the driving roller is set to be smaller than 90% of the peripheral speed (V1 described later) of the fusing roller, the braking force applied to the pressing belt is increased beyond the negligible level. In other words, if the peripheral speed (V2) of the driving roller 22 is set to be lower than 90% of the peripheral speed (V1) of the fusing roller 10, the sheet S is conveyed at a speed lower than the peripheral speed of the fusing roller 10 and an image failure is caused.

In this exemplary embodiment, therefore, the peripheral speed of the driving roller is set to be higher than 90% of the peripheral speed of the fusing roller.

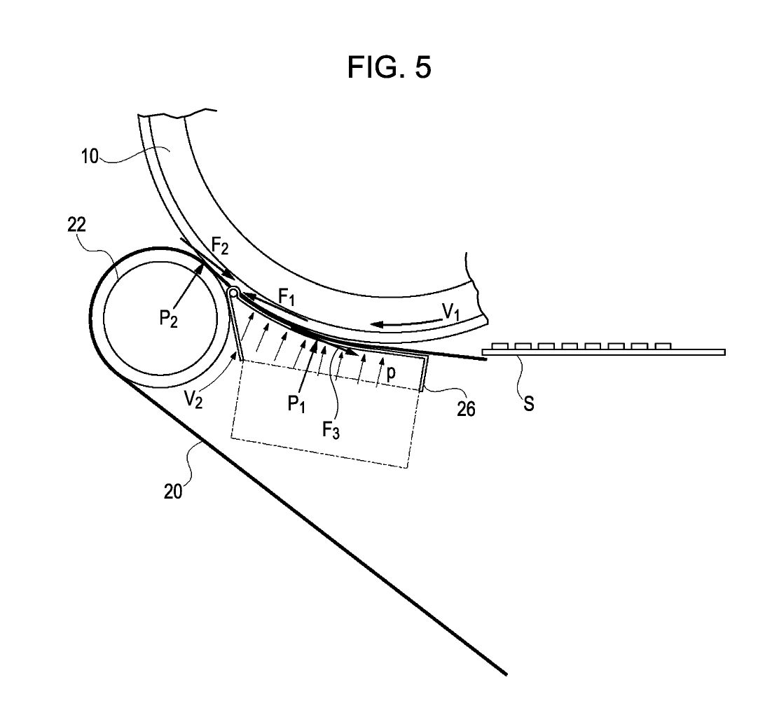

FIG. 5 is an explanatory view showing frictional forces between members sliding with each other and peripheral speeds of those members when the sheet S is conveyed.

In this exemplary embodiment, the nip is formed by bringing the driving roller 22 and the pressing pad 26 into pressure contact with the pressing belt 20. Therefore, the inner surface of the pressing belt 20 generates a sliding frictional force F2 with respect to the driving roller 22 and a sliding frictional force F3 with respect to the pressing pad 26. Assuming that “the conveying force applied to the pressing belt from the fusing roller” is F1, from the viewpoint of preventing the generation of an image shear, various conditions are set so as to satisfy;

F1>−(F2+F3)

Herein, the direction of advance of the sheet S is assumed to be positive.

F1, F2, F3, V1, V2, P1, P2, μ1, μ2, and μ3, shown in FIG. 5, represent parameters used in this exemplary embodiment. Those parameters are defined as follows:

F1: sliding frictional force between the fusing roller and the outer surface of the pressing belt (=μ1×(P1+P2))

F2: sliding frictional force between the inner surface of the pressing belt and the driving roller (=μ2×P2)

F3: sliding frictional force between the inner surface of the pressing belt and the pressing pad (=μ3×P1)

V1: peripheral speed of the fusing roller (=100 [mm/s])

V2: peripheral speed of the driving roller (=95 [mm/s])

P1: pressing force of the pressing pad (=500 [N])

P2: pressing force of the driving roller (=450 [N])

μ1: friction coefficient between the fusing roller and the outer surface of the pressing belt (=0.3)

μ2: friction coefficient between the inner surface of the pressing belt and the outer surface of the driving roller (=0.1)

μ3: friction coefficient between the inner surface of the pressing belt and the sliding sheet (=0.05)

The inlet roller 21 and the steering roller 23 are rotatably supported by bearings (not shown) and are driven for rotation by the pressing belt 20. Therefore, the respective dynamic friction coefficients between those two rollers 21, 23 and the inner surface of the pressing belt 20 are negligibly small in comparison with the dynamic friction coefficient between the inner surface of the pressing belt and the driving roller and the dynamic friction coefficient between the inner surface of the pressing belt and the sliding sheet 27. For that reason, loads imposed by the inlet roller 21 and the steering roller 23 are ignorable herein.

In this exemplary embodiment, to frictionally drive the pressing belt 20 for circulative rotation by the fusing roller 10, the friction coefficient μ1 between the fusing roller 10 and the outer surface of the pressing belt 20 is set to a value larger than the friction coefficient μ2 between the inner surface of the pressing belt 20 and the driving roller 22, namely:

μ2<μ1 (1)

Additionally, μ1 is set to be sufficiently larger than the friction coefficient μ3 between the pressing belt 20 and the sliding sheet 27.

When the friction coefficient μ1 between the fusing roller 10 and the outer surface of the pressing belt 20 is gradually increased, the efficiency in conveyance of the pressing belt 20 is increased correspondingly and an image shear due to a slip of the sheet can be more effectively prevented.

As a result of conducting the studies, however, the inventor found that, if the friction coefficient μ1 between the fusing roller 10 and the outer surface of the pressing belt 20 becomes 0.5 or more, a difficulty arises in control of a biasing force imposed on the pressing belt 20. Accordingly, the friction coefficient μ1 between the fusing roller 10 and the outer surface of the pressing belt 20 is set to a value smaller than 0.5.

On the other hand, when the friction coefficient μ1 between the fusing roller 10 and the outer surface of the pressing belt 20 is gradually reduced, the efficiency in conveyance of the pressing belt 20 is reduced correspondingly. As a result of conducting the studies, the inventor found that, if the friction coefficient μ1 between the fusing roller 10 and the outer surface of the pressing belt 20 becomes 0.2 or less, the reduction in the efficiency in conveyance of the pressing belt 20 also causes a difficulty in control of a biasing force imposed on the pressing belt 20. Accordingly, the friction coefficient μ1 between the fusing roller 10 and the outer surface of the pressing belt 20 is set to a value larger than 0.2.

Thus, the various conditions are set so as to satisfy:

0.2<μ1<0.5 (2)

Further, when the friction coefficient μ2 between the inner surface of the pressing belt 20 and the driving roller 22 is gradually increased, the frictional force generated between the pressing belt 20 and the driving roller 22 is increased to a level not negligible. As a result of conducting the studies, the inventor found that, if the friction coefficient μ2 between the inner surface of the pressing belt 20 and the driving roller 22 is set to 0.3 or more, durability of the pressing belt is greatly deteriorated due to the friction between the pressing belt 20 and the driving roller 22. Accordingly, the friction coefficient μ2 between the inner surface of the pressing belt 20 and the driving roller 22 is set to a value smaller than 0.3.

From the viewpoint of durability of the pressing belt 20, the friction coefficient μ2 between the inner surface of the pressing belt 20 and the driving roller 22 is set to be as small as possible. In this exemplary embodiment, the friction coefficient μ2 is reduced by flattening the surface of the driving roller 22. From the viewpoint of manufacturing cost, however, the process of flattening the surface of the driving roller 22 should not be performed to such an extent that the friction coefficient μ2 between the inner surface of the pressing belt 20 and the driving roller 22 becomes 0.005 or less. Further, if the friction coefficient μ2 between the inner surface of the pressing belt 20 and the driving roller 22 is 0.005 or less, the oil applied to the inner surface of the pressing belt 20 is hard to be held on the driving roller 22 and is apt to leak toward the fusing roller side. The leaked oil may cause an image failure. Accordingly, the friction coefficient μ2 between the inner surface of the pressing belt 20 and the driving roller 22 is set to a value larger than 0.005.

Thus, the various conditions are set so as to satisfy:

0.005<μ2<0.3 (3)

### (Method of Measuring Friction Coefficient)

A method of measuring the friction coefficient and measurement results will be described next.

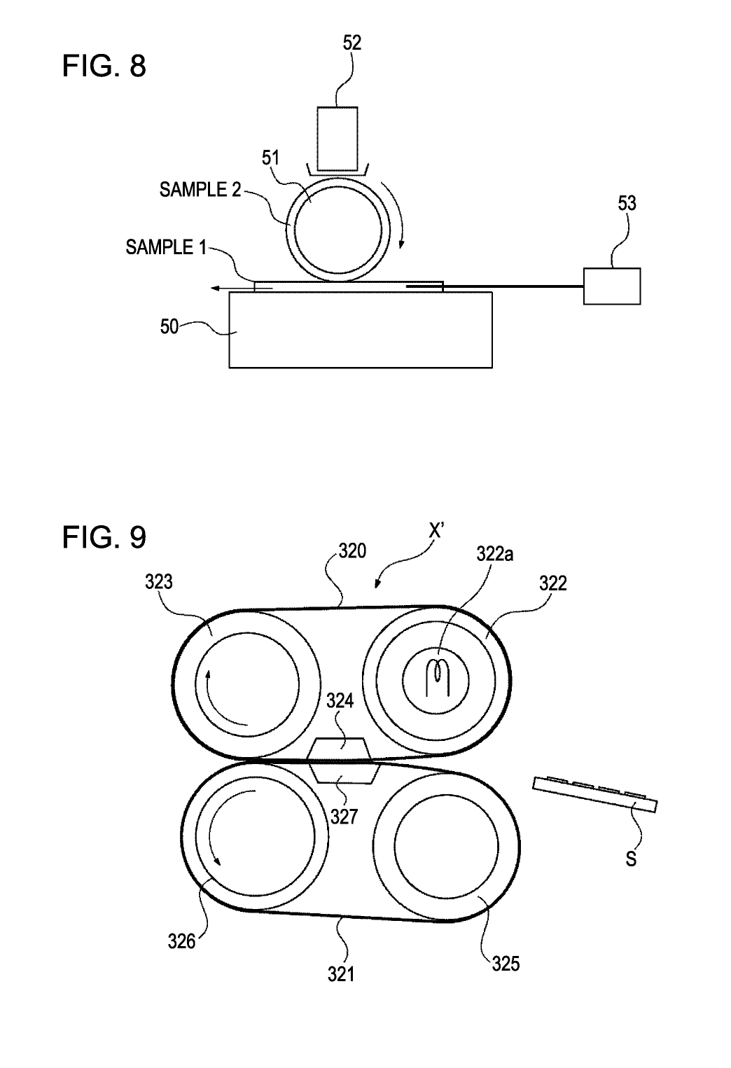

As shown in FIG. 8, one of measurement targets, i.e., a sample 1 (70 [mm]×50 [mm]), is set on a plate 50. A rotary member 51 as the other of the measurement targets, i.e., a sample 2, is held at a fixed position. The rotary member 51 corresponds to each of the fusing roller 10 and the driving roller 22 which are used in the first exemplary embodiment.

A tension gauge 53 is connected to the sample 1 before the sample 1 is set on the plate 50. The rotary member 51 is set such that the sample 1 is sandwiched between the rotary member 51 and the plate 50. A load N of 2.9 [N] is applied to the rotary member 51 by setting a weight 52.

In an indoor environment maintained at the temperature of 23° C. and the relative humidity of 50%, the rotary member 51 is rotated at a speed of 100 [mm/s] in a direction indicated by an arrow, and an output value F obtained from the tension gauge 53 at that time is read as a measurement value. Immediately after the start of the measurement, the output value F is unstable due to stick-slip, etc. In practice, therefore, a plurality of measurement values are read after the output value F has been stabilized, and an average of the plural measurement values is calculated. The output value F is affected by surface properties of the plate 50 in contact with the sample 1. In consideration of such an effect, the output value F is normalized based on a calculation formula prepared in advance and is substituted into a formula mentioned below.

The friction coefficient μ is calculated by substituting an average of the plural output values F (after the normalization) of the tension gauge 53, which have been measured in accordance with the above-described method, into the following formula:

F=μ×N (μ: friction coefficient and N: load)

In this exemplary embodiment, measurement results of μ1=0.3, μ2=0.1, and μ3=0.05 are obtained.

### (Changes in Behavior of Pressing Belt Depending on Peripheral Speed of Driving Roller)

The inventor actually conducted the fusing process under the above-mentioned conditions and found that unevenness of an image gloss is caused depending on the peripheral speed of the driving roller.

Regarding the generation of unevenness of the image gloss, the inventor made such a hypothesis that the unevenness of the image gloss is attributable to changes in behavior of the pressing belt, which are caused near an exit of the fusing nip with changes in the peripheral speed of the driving roller. In other words, based on the hypothesis, separability of the sheet S from both the fusing roller and the pressing belt is changed due to the changes in behavior of the pressing belt, thus generating an area of high gloss and an area of low gloss in an image formed on the sheet S.

To confirm the relationship between the behavior of the pressing belt near the exit of the fusing nip and the unevenness of the image gloss, the inventor observed the behavior of the pressing belt by installing a high-speed camera at a side of the fusing apparatus X. Stated another way, the behavior of the pressing belt was observed in the actual situation of the fusing process, i.e., in the state where the pressing belt was brought into pressure contact with the fusing roller. In a verification test described below, the parameters were changed to various values to confirm the cause-effect relationship between the behavior of the pressing belt and the peripheral speed of the driving roller.

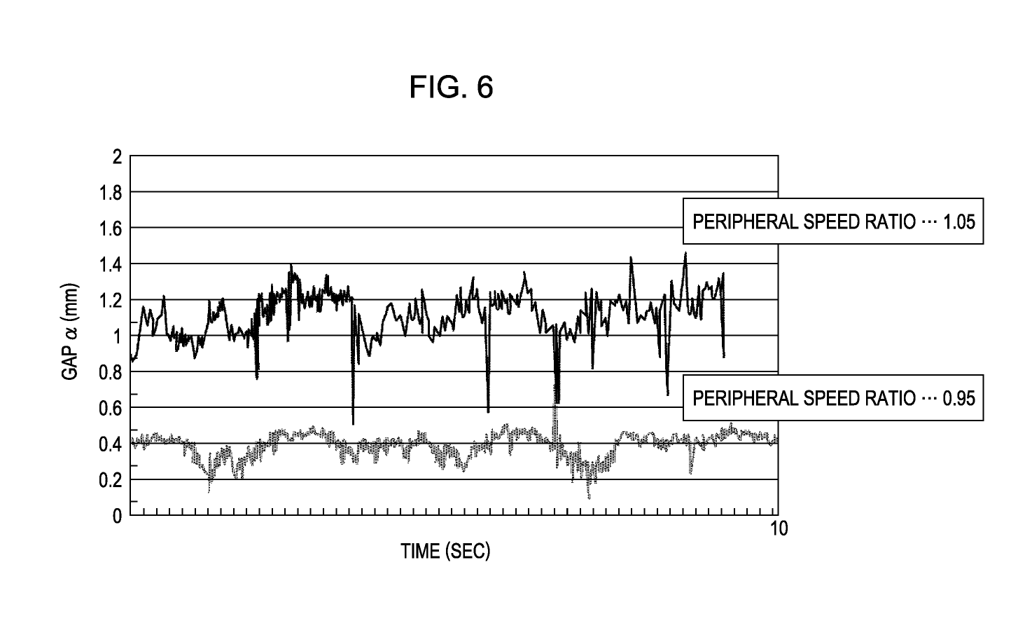

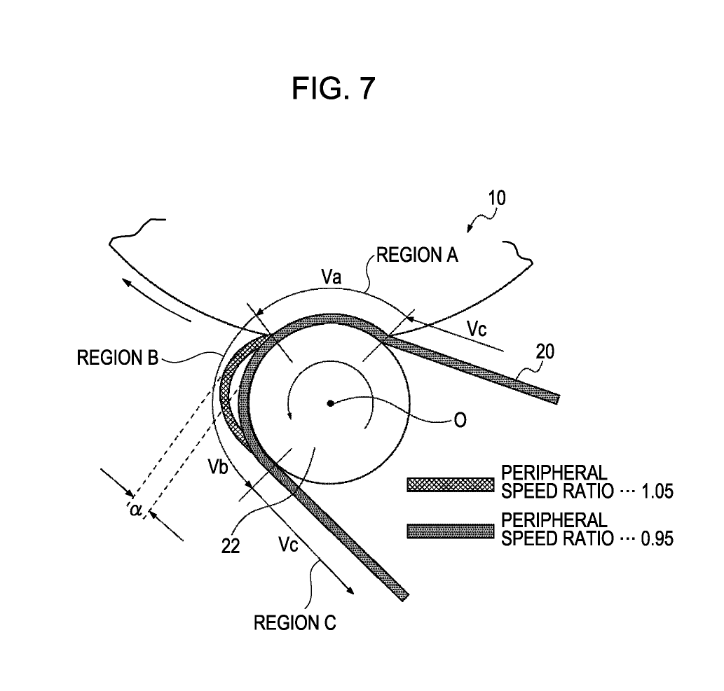

FIG. 6 is a graph showing results of observing the behavior of the pressing belt when a peripheral speed ratio (V2/V1) of the driving roller to the fusing roller is set to 0.95 and 1.05. The vertical axis of FIG. 6 represents a maximum gap α (see FIG. 7) between the surface of the driving roller and a portion of the pressing belt in a region where the pressing belt is floated (departed) from the surface of the driving roller 22 near the exit of the fusing nip, the region being most spaced from the driving roller. The gap α represents a distance measured in a direction parallel to the radial direction of the driving roller. The measurement of the gap α is performed by displaying, on a monitor, an image picked up by the high-speed camera, determining a distance on the image corresponding to the gap α on the monitor, and converting the distance on the image to an actual value (mm) of the gap α. The horizontal axis of FIG. 6 represents time. In the first exemplary embodiment, about 330 images are picked up at intervals 0.03 sec for a period of 10 sec.

Table 1, given below, shows the measurement results when the peripheral speed ratio is set to various values including the aforesaid two values. In an item of “unevenness of image gloss” in Table 1, a mark ◯ means that the unevenness of the image gloss is not generated, and a mark × means that the unevenness of the image gloss is generated.

As seen from the results of the verification test, when the driving roller is rotated at a lower peripheral speed than the fusing roller, the floating of the pressing belt from the driving roller is negligible near the exit of the fusing nip and the state of contact between the driving roller and the pressing belt is stable. Thus, the unevenness of the image gloss is not generated.

On the other hand, when the driving roller is rotated at a higher peripheral speed than the fusing roller, the floating of the pressing belt from the driving roller is increased near the exit of the fusing nip and the state of contact between the driving roller and the pressing belt is unstable. More specifically, of the toner image on the sheet, the image gloss is increased in an area of the toner image where the sheet contacts the pressing belt, which is in the floated state near the exit of the fusing nip, while the image gloss is not increased in other areas where the sheet does not contact the floated pressing belt. Consequently, the unevenness of the image gloss is generated between those two areas.

TABLE 1

| Peripheral Speed Ratio | | Unevenness of |
|---|---|---|
| (V2/V1) | Belt Behavior | Image Gloss |
| Less than 0.90 | stable | ◯ |
| 0.90 to less than 1.00 | stable | ◯ |
| 1.00 to less than 1.10 | unstable | X |
| Not less than 1.10 | unstable | X |

Thus, it was confirmed that when the behavior of the pressing belt is unstable near the exit of the fusing nip, the unevenness of the image gloss is generated and an image failure is caused.

FIG. 7 illustrates the behavior of the pressing belt. The cause of making the contact between the pressing belt and the driving roller unstable will be described with reference to FIG. 7.

In the fusing apparatus of the first exemplary embodiment, since the pressing belt is frictionally driven for circulative rotation by the fusing roller, the friction coefficient between the driving roller and the inner surface of the pressing belt 20 is set to a sufficiently small value. However, if the driving roller is rotated at a higher peripheral speed than the fusing roller, the driving roller imposes, though slightly, a force acting to drive the pressing belt and the state of contact between the driving roller and the pressing belt becomes unstable near the exit of the fusing nip.

Further, as shown in FIG. 7, the speed of the pressing belt near the driving roller differs, though slightly, in three regions. Herein, it is assumed that Va represents the belt speed in a portion of the pressing belt (i.e., a region A) in which the pressing belt contacts the fusing roller and the nip is formed by the driving roller pressed toward the fusing roller. Also, Vb represents the belt speed in a portion of the pressing belt (i.e., a region B) in which the pressing belt contacts the driving roller or it is in the unstable contact state immediately downstream of the fusing nip. Further, Vc represents the belt speed in a portion of the pressing belt (i.e., a region C) in which the pressing belt does not contact the driving roller. Note that, in the first exemplary embodiment, the peripheral speed V2 of the driving roller 22 corresponds to Vc.

In addition, because the entire system of the fusing apparatus is constructed such that the pressing belt is frictionally driven for circulative rotation by the fusing roller, the relationship of V1≈Vc is held.

Further, because the fusing nip is formed by the driving roller biting into the elastic layer of the fusing roller, the relationship of Va>V1≈Vc is held in consideration of the diameter of the driving roller and a deformation of the elastic layer of the fusing roller.

Based on the relationship of Va>Vc, Vb acts to absorb the speed difference between Va and Vc.

As illustrated in FIG. 7, the gap α between the driving roller and the pressing belt near the exit of the fusing nip is not zero (0) in fact. The reason is that the driving roller deforms the elastic layer of the fusing roller and the speed difference between those two rollers is necessarily caused. Looking at stability in the belt behavior, the behavior of the pressing belt is more stable when the gap α between the driving roller and the pressing belt near the exit of the fusing nip takes a smaller distance.

If the driving roller is rotated at a higher peripheral speed than the fusing roller, the difference between Va and Vc is increased. In practice, because the pressing belt is frictionally driven for circulative rotation by the fusing roller, Vc is not changed and Va is increased. The reason is, as described above, that the driving roller imposes, though slightly, a force acting to drive the pressing belt. This causes a phenomenon that the speed difference generated in the region A cannot be absorbed in the region B and the pressing belt departs from the driving roller and the belt behavior becomes unstable.

The degree of contact between the pressing belt and the driving roller can be increased, for example, by a method of increasing a tensile force (tension) of the pressing belt. The inventor conducted a verification test by observation on the belt behavior in a similar manner to the above-described case in a state where the tension of the pressing belt was increased.

As a result of the verification test, the inventor found that the contact between the pressing belt and the driving roller is kept stable even when the driving roller is rotated at a higher peripheral speed than the fusing roller. However, increasing the tension of the pressing belt is not a desirable solution because it becomes impossible to control the biasing force imposed on the pressing belt.

As seen from the results of the verification tests described above, the peripheral speed ratio (V2/V1) of the driving roller to the fusing roller is to be set smaller than 1.0 for the purpose of suppressing the unevenness of the image gloss. Namely:

V2/V1<1.0 (4)

(Relationship between Peripheral Speed of Driving Roller and Image Shear)

A verification test was also conducted on the generation of “image shear” in addition to the generation of “gloss unevenness”. More specifically, in a state of the peripheral speed of the fusing roller being set to a fixed value of 100 [mm/s], a verification test was made on the generation of “image shear” and “gloss unevenness” when the peripheral speed of the driving roller was changed to various values. Further, the verification test was made while changing a proportion of an image formed on the sheet and environmental conditions.

Table 2 shows the results of such a verification test. In an item of “image shear” in Table 2, a mark “×” represents the case where the image shear is apparently recognized and the image is visually abnormal, a mark “Δ” represents the case where the image shear is slightly recognized, but the image is visually normal, and a mark “◯” represents the case where the image shear is not recognized. Also, in an item of “gloss unevenness”, a mark “×” represents the case where the gloss unevenness is apparently recognized in the image, a mark “Δ” represents the case where the gloss unevenness is slightly recognized, but it is not noticeable, and a mark “◯” represents the case where the gloss unevenness is not recognized. Further, “normal environment” means an environment in which the temperature is 23° C. and the relative humidity is 50%. “High-temperature and high-humidity environment” means an environment in which the temperature is 30° C. and the relative humidity is 85%. Moreover, “low-duty image” means that the proportion of the image formed on the sheet is 5%. “High-duty image” means that the proportion of the image formed on the sheet is 100%. The term “proportion of the image” means a percentage of the area of a zone where the toner is coated on the sheet with respect to the total area of a zone where the image can be formed on the sheet.

TABLE 2

| | Image Shear | | | | |
|---|---|---|---|---|---|
| | | | High-Temperature | | |
| | Normal | | and-Humidity | | |
| Peripheral | Environment | | Environment | | Gloss |
| Speed | Low-Duty | High-Duty | Low-Duty | High-Duty | Un- |
| Ratio | Image | Image | Image | Image | evenness |
| Frictionally | ◯ | Δ | Δ | X | ◯ |
| driven | | | | | |
| 0.7 | Δ | X | X | X | ◯ |
| 0.8 | ◯ | Δ | Δ | X | ◯ |
| 0.85 | ◯ | Δ | Δ | Δ | ◯ |
| 0.9 | ◯ | ◯ | ◯ | Δ | ◯ |
| 0.93 | ◯ | ◯ | ◯ | ◯ | ◯ |
| 0.95 | ◯ | ◯ | ◯ | ◯ | ◯ |
| 0.97 | ◯ | ◯ | ◯ | ◯ | ◯ |
| 0.99 | ◯ | ◯ | ◯ | ◯ | ◯ |
| 1.01 | ◯ | ◯ | ◯ | ◯ | X |
| 1.03 | ◯ | ◯ | ◯ | ◯ | X |
| 1.05 | ◯ | ◯ | ◯ | ◯ | X |

As seen from the results of the verification test shown in Table 2, by setting the peripheral speed ratio of the driving roller to the fusing roller to be larger than 0.90, the generation of both the gloss unevenness and the image shear can be prevented. If the peripheral speed ratio of the driving roller to the fusing roller is set to 0.90 or less, the driving roller causes a braking force to act on the pressing belt at a level not negligible and the image shear is generated. In other words, the sheet S slips (or moves at a slower speed) relative to the fusing roller to such an unnegligible extent that the image shear is generated. Further, as seen from the results shown in Table 2, the phenomenon of the image shear is more apt to occur with the image having a higher duty. For the reason described above, the following relation formula (5) is desirably satisfied:

0.9<V2/V1 (5)

Thus, based on both the relationships expressed by the formulae (4) and (5), V1 and V2 are desirably set so as to satisfy:

0.9<V2/V1<1.0 (6)

In addition, as seen from the results shown in Table 2, the phenomenon of the image shear is more apt to occur at higher humidity. Taking into account the case of the high-temperature and high-humidity environment, therefore, the peripheral speed ratio of the driving roller to the fusing roller is desirably set to be larger than 0.93. For the reason described above, the following relation formula (7) is desirably satisfied:

0.93<V2/V1 (7)

Thus, based on both the relationships expressed by the formulae (4) and (7), V1 and V2 are desirably set so as to satisfy:

0.93<V2/V1<1.0 (8)

In short, when the following conditions (1), (2), (3) and (6) are satisfied, the behavior of the pressing belt can be stabilized. As a result, a high-quality image free from the gloss unevenness and the image shear can be provided.

μ2<μ1 (1)

0.2<μ1<0.5 (2)

0.005<μ2<0.3 (3)

0.9<V2/V1<1.0 (6)

Herein, μ1 is the friction coefficient between the fusing roller and the pressing belt, μ2 is the friction coefficient between the pressing belt and the driving roller, V1 is the peripheral speed of the fusing roller, and V2 is the peripheral speed of the driving roller.

Further, in order to provide the high-quality image free from the gloss unevenness and the image shear even when the atmosphere environment of the apparatus is varied over a wide range, the following condition (8) is desirably satisfied:

0.93<V2/V1<1.0 (8)

### Second Exemplary Embodiment

A modified fusing apparatus as one practical form of the image heating apparatus according to a second exemplary embodiment of the present invention will be described below.

While the first exemplary embodiment has been described in connection with the case where the member contacting the not-yet-fused toner image on the sheet is a roller (i.e., the fusing roller), that member is formed of a belt in this second exemplary embodiment. Stated another way, a fusing apparatus X′ according to this second exemplary embodiment uses belts on both the fusing side and the pressing side.

Since the second exemplary embodiment is constructed substantially similarly to the first exemplary embodiment except for the construction of a later-described fusing belt, a detailed description of the same construction is omitted here.

FIG. 9 is a schematic sectional view of the fusing apparatus X′ employing belts on both the fusing side and the pressing side.

A fusing unit which is brought into contact with the not-yet-fused toner image for fusing includes an endless fusing belt 320 which serves as a hating rotary member, rollers 323 and 322 around which the fusing belt 320 is supported to stretch under tension, and a fusing pad 324. The roller 323 is, though not shown in FIG. 9, connected to the driving motor M through the driving gear train G as in the first exemplary embodiment (FIG. 4), and it has the function of driving the fusing belt 320. The roller 322 has the function of a tension roller. A halogen heater 322a is installed inside the tension roller 322.

A pressing unit includes, as in the first exemplary embodiment, an endless pressing belt 321, rollers 325 and 326 around which the pressing belt 321 is supported to stretch under tension, and a pressing pad 327. A driving force is input to the roller 326 as with the driving roller 22 in the first exemplary embodiment (FIG. 4). More specifically, the roller 326 is connected to the driving motor M through the driving gear train G, and it has the function of a driving roller for driving the pressing belt 321. The roller 325 has the function of a tension roller.

With the construction described above, the second exemplary embodiment can also provide similar advantages to those of the first exemplary embodiment by reading the peripheral speed V1 of the fusing roller 10 in the first exemplary embodiment as the peripheral speed of the fusing belt 320 in the second exemplary embodiment.

Thus, when the following four relation formulae are satisfied, the behavior of the pressing belt is stabilized so that a high-quality image free from the gloss unevenness and the image shear can be obtained:

μ2<μ1

0.2<μ1<0.5

0.005<μ2<0.3

0.9<V2/V1<1.0

Herein, μ1 is the friction coefficient between the fusing belt 320 and the pressing belt 321, μ2 is the friction coefficient between the pressing belt 321 and the driving roller 326, V1 is the peripheral speed of the fusing belt 320, and V2 is the peripheral speed of the driving roller 326.

Further, as in the first exemplary embodiment, to provide the high-quality image free from the gloss unevenness and the image shear even when the atmosphere environment of the apparatus is varied over a wide range, the following relation formula is desirably satisfied:

0.93<V2/V1<1.0

While the first and second exemplary embodiments are described in connection with the case where the present invention is applied to a monochrome image forming apparatus, the present invention can also be applied to, e.g., a full-color image forming apparatus shown in FIG. 10. The construction of the full-color image forming apparatus employing the fusing apparatus X according to the first exemplary embodiment will be described in brief below. As an alternative, the fusing apparatus X′ according to the second exemplary embodiment is also applicable.

First, second, third and fourth image forming units Pa, Pb, Pc and Pd jointly constituting a full-color image forming unit are installed side by side within the apparatus shown in FIG. 10. In those image forming units, toner images of different colors are each formed through steps of formation of a latent image, development, and transfer.

The image forming units Pa, Pb, Pc and Pd have respective dedicated image bearing members, i.e., electrophotographic photosensitive drums 303a, 303b, 303c and 303d in the illustrated example.

Drum chargers 302a-302d, developers 301a-301d, primary transfer chargers 331a-331d, and cleaners 304a-304d are disposed respectively around the photosensitive drums 303a-303d. Further, a light source unit and a polygonal mirror, both not shown, are installed in an upper portion of the apparatus.

A laser beam emitted from the light source unit is scanned with rotation of the polygonal mirror. The scanned laser beam is deflected by a reflecting mirror and condensed by an fθ lens for exposure to the photosensitive drums 303a-303d at their generatrices. As a result, a latent image corresponding to an image signal is formed on each of the photosensitive drums 303a-303d.

In the developers 301a-301d, toners of yellow, magenta, cyan and black are filled as developing agents in predetermined amounts through hoppers Ea-Ed, respectively. The developers 301a-301d develop the latent images on the photosensitive drums 303a-303d to visualize them as a cyan toner image, a magenta toner image, a yellow toner image, and a black toner image, respectively.

An intermediate transfer member 330 is disposed under the photosensitive drums 303a-303d and is circulatively rotated in a direction indicated by an arrow.

The yellow toner image formed on the photosensitive drum 303a is transferred onto an outer peripheral surface of the intermediate transfer member 330 by application of a primary transfer bias from the primary transfer roller 331a.

Similarly, a magenta toner image, a cyan toner image, and a black toner image are successively transferred onto the intermediate transfer member 330 in a superimposed relation, whereby a composite color toner image corresponding to an objective color image is formed.

A secondary transfer roller 311 is supported by bearings and is disposed to extend parallel to the intermediate transfer member 330 while contacting a lower surface of the intermediate transfer member 330 at its lowermost portion. A desired secondary transfer bias is applied to the secondary transfer roller 311 from a secondary transfer bias source. The composite color toner image having been transferred onto the intermediate transfer member 330 in the superimposed relation is transferred onto the sheet S as follows. The sheet S is fed from a paper feed cassette 300 to a nip between the intermediate transfer member 330 and the secondary transfer roller 311, which are held in pressure contact with each other, at predetermined timing after passing a registration roller pair 312 and a pre-transfer guide. At the same time, the secondary transfer bias is applied to the secondary transfer roller 311 from the secondary transfer bias source. The composite color toner image is transferred from the intermediate transfer member 330 onto the sheet S by application of the secondary transfer bias.

After the end of the primary transfer, the photosensitive drums 303a-303d are cleaned respectively by cleaners 304a-304d which remove the toners remaining on the photosensitive drums 303a-303d, and are made ready for the formation of the latent image and the subsequent processes in the next cycle. The toners and other foreign matters remaining on the intermediate transfer member 330 are wiped out by a cleaner 340. In the second exemplary embodiment, the cleaner 340 is made of a take-up cleaning web (unwoven fabric) that is brought into pressure contact with the surface of the intermediate transfer member 330 for cleaning it.

The sheet S including the composite color toner image transferred thereto is introduced to the fusing apparatus X. The sheet S including the composite color toner image is heated and pressed by the fusing apparatus X so that the image is fused for fixing to the sheet. Then, the sheet S is ejected onto a paper output tray through a paper ejecting section 363.

The fusing apparatus using a belt, as illustrated in the exemplary embodiment of the present invention, is suitably applied to the color image forming apparatus in which the toner image formed on the sheet contains a larger amount of toner than the monochrome image.

While the above description has been made of the fusing apparatus as one practical form of the image heating apparatus, the present invention can be also similarly applied to other apparatuses. For example, the present invention is similarly applicable to a gloss increasing apparatus which reheats a toner image having been fused on a sheet for the purpose of increasing a gloss of the toner image.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims the benefit of Japanese Application No. 2007-039336 filed Feb. 20, 2007, which is hereby incorporated by reference herein in its entirety.

What is claimed is:

1. An image heating apparatus comprising:
a heating rotary member configured to heat a toner image on a recording material at a nip portion;
a driving mechanism configured to drive the heating rotary member;
an endless belt arranged to form the nip portion between the heating rotary member and the endless belt; and
a driving roller configured to drive the endless belt and to press the endless belt toward the heating rotary member,
wherein the following expressions are satisfied:
μ2<μ1
0.2<μ1<0.5
0.005<μ2<0.3
0.9<V2/V1<1.0
where μ1 is a friction coefficient between the heating rotary member and the endless belt, μ2 is a friction coefficient between the endless belt and the driving roller, V1 is a peripheral speed of the heating rotary member, and V2 is a peripheral speed of the driving roller.

2. The image heating apparatus according to claim 1, wherein the following expression is satisfied:
0.93<V2/V1<1.0.

3. The image heating apparatus according to claim 1, wherein the endless belt in contact with the heating rotary member is driven by the heating rotary member.

4. The image heating apparatus according to claim 1,
wherein, when the heating rotary member and the endless belt are in contact with each other, a peripheral speed of the endless belt is substantially the same as the peripheral speed of the heating rotary member, and
wherein, when the heating rotary member and the endless belt are not in contact with each other, the peripheral speed of the endless belt is substantially the same as the peripheral speed of the driving roller.

5. The image heating apparatus according to claim 1, wherein the heating rotary member includes a roller.

6. The image heating apparatus according to claim 1, wherein the heating rotary member includes an endless belt, the driving mechanism includes a driving roller configured to drive the endless belt as the heating rotary member.

7. The image heating apparatus according to claim 1, wherein the heating rotary member and the endless belt fix the toner image onto the recording material by heating and pressing at the nip portion.
